(19) United States
(12) Patent Application Publication
(10) Pub. No.: US 2021/0286461 A1
(43) Pub. Date: Sep. 16, 2021

(54) METHOD AND DEVICE FOR ADJUSTING DISPLAY OF MULTIMEDIA BLACKBOARD, MEDIUM AND ELECTRONIC DEVICE

(71) Applicant: Ambow Sihua intelligent Technology Co., Ltd., Beijing (CN)

(72) Inventors: Jin Huang, Beijing (CN); Qiaoling Xu, Beijing (CN); Gang Huang, Beijing (CN); Kesheng Wang, Beijing (CN); Zhengke Hou, Beijing (CN); Zheyu Wu, Beijing (CN)

(73) Assignee: Ambow Sihua intelligent Technology Co., Ltd., Beijing (CN)

(21) Appl. No.: 16/845,444

(22) Filed: Apr. 10, 2020

(30) Foreign Application Priority Data
Mar. 16, 2020 (CN) 202010183217.6

(51) Int. Cl. G06F 3/041; A47B 97/00; G06F 1/16; G09B 5/10

(52) U.S. Cl. CPC G06F 3/0416; G09B 5/10; G06F 1/16; A47B 97/001

(57) ABSTRACT

The present disclosure provides a method and a device for adjusting display of a multimedia blackboard, a medium, and an electronic device. The method includes: obtaining brightness simultaneously acquired by a plurality of light sensors of the multimedia blackboard; analyzing the brightness and perform a smooth processing to generate a first brightness distribution image; obtaining a next frame display image and a backlight brightness of a display device; adjusting a pixel color attribute value of a frame pixel in the next frame display image and/or the backlight brightness according to a preset visual adjustment information, the first brightness distribution image, the next frame display image, and the backlight brightness.

### CROSS-REFERENCE TO RELATED APPLICATION

This application claims the benefit of Chinese Patent Application No. 202010183217.6 filed on Mar. 17, 2020 in the National Intellectual Property Administration of China, the whole disclosure of which is incorporated herein by reference.

### TECHNICAL FIELD

The present disclosure relates to the field of computer technology, and in particular, to a method and a device for adjusting display of a multimedia blackboard, a medium, and an electronic device.

### BACKGROUND

The traditional blackboard is a plane that can be written repeatedly, the surface thereof is hard, and it is a writing tool that can be repeatedly erased. It is commonly used for teaching, conference discussions, or personal and family notes. With the popularization of computer technologies, a multimedia computer-assisted teaching equipment has become a common device in the classrooms of educational institutions. Since multimedia contents must be prepared before the lesson, and it is complicated to edit multimedia contents on the spot, a multimedia blackboard comes into being. The multimedia blackboard combines the functions of multimedia with the functions of the traditional blackboard. It is feasible to write on the multimedia blackboard and to play multimedia materials in the multimedia blackboard. For example, the multimedia blackboard includes two display regions, one display region displays a lecture video showing the lecturer's body, and the other display region displays a lecture content of the lecturer, such as the PPT lecture content.

Due to the high height and large area of the multimedia blackboard, it is inevitable that, due to the surface material, diffuse reflection and/or specular reflection will occur when light is incident on it. When the multimedia blackboard is viewed from a certain angle, due to a large specular reflection intensity, it will be very dazzling when viewing the multimedia blackboard from this angle, and the display content of the multimedia blackboard cannot be seen clearly.

### SUMMARY

This section of summary is provided to introduce conceptions in a simplified form, and the conceptions are further described below in the section of detail description of the embodiments. The section of summary is not intended to identify key features or essential features of the claimed technical solutions, nor is it intended to be used to limit the scope of the claimed technical solutions.

An object of the present disclosure is to provide a method and a device for adjusting display of a multimedia blackboard, a medium, and an electronic device, which can solve at least one of the technical problems mentioned above. The specific schemes are as follows:

According to a specific embodiment of the present disclosure, in a aspect, the present disclosure provides a method for adjusting display of a multimedia blackboard, comprising:

obtaining a set of brightnesses simultaneously acquired by a plurality of light sensors corresponding to each display device of the multimedia blackboard, wherein, the multimedia blackboard comprises: a transparent writing board, at least one or more display devices hermetically attached to an entire back of the writing board, and the plurality of light sensors provided in the writing board;

analyzing the set of brightnesses and perform a smooth processing to generate a first brightness distribution image of the corresponding display device;

obtaining a next frame display image and a backlight brightness of each display device; and

adjusting a pixel color attribute value of a frame pixel in the next frame display image and/or the backlight brightness of the corresponding display device according to a preset visual adjustment information, the first brightness distribution image, the next frame display image, and the backlight brightness of each display device.

According to a specific embodiment of the present disclosure, in a aspect, the present disclosure provides a device for adjusting display of a multimedia blackboard, which is applied to a multimedia blackboard, the multimedia blackboard comprising: a transparent writing board, at least one or more display devices hermetically attached to an entire back of the writing board, and the plurality of light sensors provided in the writing board, wherein the device comprises:

a brightness obtaining unit, configured to obtain a set of brightnesses simultaneously acquired by a plurality of light sensors corresponding to each display device of the multimedia blackboard;

a first brightness distribution image generating unit, configured to analyze the set of brightnesses and perform a smooth processing to generate a first brightness distribution image of the corresponding the display device;

an auxiliary information obtaining unit, configured to obtain a next frame display image and a backlight brightness of each display device; and

an adjusting unit, configured to adjust a pixel color attribute value of a frame pixel in the next frame display image and/or the backlight brightness of the corresponding display device according to a preset visual adjustment information, the first brightness distribution image, the next frame display image, and the backlight brightness of each display device.

According to a specific embodiment of the present disclosure, in a aspect, the present disclosure provides a computer-readable storage medium in which a computer program is stored, wherein when the program is executed by a processor, the method according to any one of the first aspect is implemented.

According to a specific embodiment of the present disclosure, in a aspect, the present disclosure provides an electronic device, comprising: a transparent writing board; at least one or more display devices hermetically attached to an entire back of the writing board; a plurality of light sensors provided in the writing board; one or more processors; a storage device configured to store one or more programs, wherein when the one or more programs are executed by the one or more processors, the one or more processors are caused to implement the method according to any one of the first aspect.

Compared with the prior art, the foregoing schemes in the embodiments of the present disclosure have at least the following beneficial effects:

the present disclosure provides a method and a device for adjusting display of a multimedia blackboard, a medium, and an electronic device.

In the present disclosure, before displaying the next frame display image, the pixel color attribute value of the image and/or the backlight brightness are adjusted according to the brightness of light illuminating the multimedia blackboard, which reduces the impact of ambient light on viewing the multimedia blackboard and improves the comfort of viewing the multimedia blackboard.

### BRIEF DESCRIPTION OF THE DRAWINGS

The above and other features, advantages, and aspects of the embodiments of the present disclosure will become more apparent with reference to the drawings and the following specific implementations. Throughout the drawings, the same or similar reference numerals indicate the same or similar elements. It should be understood that the drawings are schematic and the originals and elements are not necessarily drawn to scale. In the drawings:

FIG. 1 shows a flowchart of a method for adjusting display of a multimedia blackboard according to an embodiment of the present disclosure;

FIG. 2 shows a front view of a multimedia blackboard of a method for adjusting display of a multimedia blackboard according to an embodiment of the present disclosure;

FIG. 3 shows a side view of a multimedia blackboard according to a method for adjusting display of a multimedia blackboard according to an embodiment of the present disclosure;

FIG. 4 shows a block diagram of a device for adjusting display of a multimedia blackboard according to an embodiment of the present disclosure;

FIG. 5 is a schematic diagram of a connection structure of an electronic device according to an embodiment of the present disclosure.

### DETAILED DESCRIPTION OF THE EMBODIMENTS

Hereinafter, embodiments of the present disclosure will be described in more detail with reference to the accompanying drawings. Although the drawings show certain embodiments of the present disclosure, it should be understood that the present disclosure may be implemented in various forms and should not be construed as limited to the embodiments set forth herein, but rather these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the steps recorded in this publicly available method implementation modality can be performed in different order and/or in parallel. In addition, the method implementation may include additional steps and/or omit the steps shown for execution. The scope of this disclosure is unrestricted in this respect.

The term “include” used in this paper and its deformation is open to include, i.e. “include but not limited to”. The term “based” is “at least partially based”. the term “one embodiment” means “at least one embodiment”; the term “another embodiment” means “at least one other embodiment”; and the term “some embodiments” means “at least some embodiments”. Relevant definitions of other terms are given in the following description.

It is important to note that the concepts of “first” and “second” mentioned in this disclosure are only used to distinguish between different devices, modules or units and are not used to define the order or interdependence of the functions performed by these devices, modules or units.

It should be noted that the modification of “one”, “multiple” mentioned in this disclosure is indicative rather than restrictive, and the technical staff in this field should understand that it should be understood as “one or more” unless otherwise specified in the context.

The names of messages or information that interact with multiple devices in this public implementation are used only for illustrative purposes and not for limiting the scope of such messages or information.

Hereinafter, optional embodiments of the present disclosure will be described in detail with reference to the accompanying drawings.

A embodiment provided by the present disclosure is an embodiment of a method for adjusting display of a multimedia blackboard.

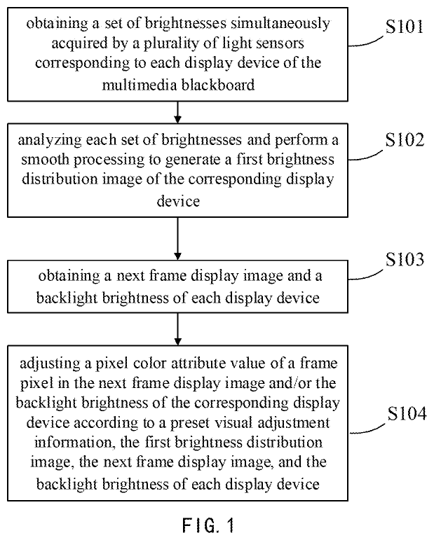

The embodiment of the present disclosure is described in detail below with reference to FIGS. 1 to 3. Please refer to FIG. 1.

Step S101: obtaining a set of brightnesses simultaneously acquired by a plurality of light sensors corresponding to each display device of the multimedia blackboard.

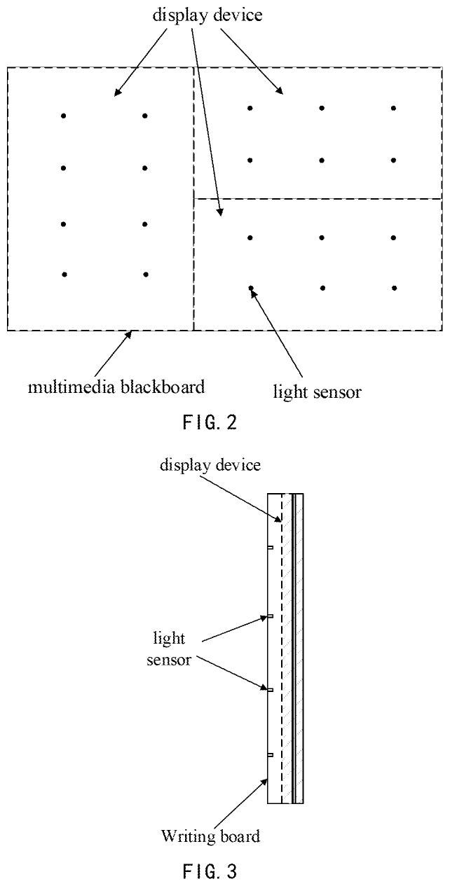

The method described in the embodiment of the present disclosure is applied to a multimedia blackboard. Please refer to FIG. 2 and FIG. 3, the multimedia blackboard includes a transparent writing board, at least one or more display devices hermetically attached to an entire back of the writing board, and a plurality of light sensors provided in the writing board.

When the display device of the multimedia blackboard displays black or dark green or other solid colors, the multimedia blackboard is appropriate for writing on the writing board like an ordinary blackboard. When the display device displays an image, the multimedia blackboard can play multimedia contents. For example, the multimedia blackboard has two display devices, one of which plays a teacher's lecture image, and one of the teacher's lecture contents.

The acquired brightness is a brightness of ambient light on the writing board.

Optionally, the plurality of light sensors provided in the writing board constitute a light sensor array.

The step of obtaining a set of brightnesses simultaneously acquired by a plurality of light sensors corresponding to each display device of the multimedia blackboard includes:

step S101-1, obtaining a set of brightnesses simultaneously acquired by a light sensor array corresponding to each display device of the multimedia blackboard.

The light sensor array can be used to obtain the brightness of the writing board uniformly to adjust the display of the multimedia blackboard accurately, and the more light sensors, the more accurate the adjustment.

The light sensor may be embedded in the display device, and a sensor head of the sensor is provided in the writing board.

Step S102, analyzing each set of brightnesses and perform a smooth processing to generate a first brightness distribution image of the corresponding display device.

A brightness distribution image is an image that represents the brightness by color. Since the embodiment of the present disclosure uses multiple light sensors to acquire the brightnesses of the local points, the brightnesses of the local points needs to be smoothed to generate the first brightness distribution image.

Step S103, obtaining a next frame display image and a backlight brightness of each display device.

The backlight brightness is a brightness that can be physically adjusted by an instruction in the display device.

The next frame display image is an image to be displayed in a next frame of a currently displayed image in the display device. In the embodiment of the present disclosure, before the next frame display image is displayed, a pixel color attribute value of a pixel of the display image of the next frame and/or the backlight brightness are adjusted to reduce the interference of ambient light on viewing the multimedia blackboard, and to improve comfort of viewing the multimedia blackboard.

Step S104, adjusting a pixel color attribute value of a frame pixel in the next frame display image and/or the backlight brightness of the corresponding display device according to a preset visual adjustment information, the first brightness distribution image, the next frame display image, and the backlight brightness of each display device.

The pixel color attribute value includes: a contrast value, a color level value, a color temperature value, a color tone value, and/or a saturation value.

Optionally, the step of adjusting a pixel color attribute value of a frame pixel in the next frame display image and/or the backlight brightness of the corresponding display device according to a preset visual adjustment information, the first brightness distribution image, the next frame display image, and the backlight brightness of each display device includes the following steps:

Step S104-1, generating a second brightness distribution image according to the first brightness distribution image and the backlight brightness.

The backlight brightness is used to improve the comfort of viewing the multimedia blackboard. However, when the backlight brightness meets an ambient light brightness, it may become a brightness that impairs comfort. Therefore, the embodiment of the present disclosure considers the ambient light brightness and the backlight brightness together.

Step S104-2, generating a visual effect image corresponding to the next frame display image according to the second brightness distribution image and the next frame display image.

The visual effect image is an image generated by superimposing a variety of environmental factors on the next frame display image, and is used to simulate the effect of viewing the next frame display image in an actual environment.

Step S104-3, adjusting the backlight brightness according to the visual adjustment information, the next frame display image, and the visual effect image, and/or adjusting the pixel color attribute value of the frame pixel in the next frame display image according to the visual adjustment information, the visual effect image, the first brightness distribution image, the next frame display image and the backlight brightness.

Three specific embodiments are provided by the present disclosure with respect to step S104-3.

### The Embodiment

The visual adjustment information includes an effect level and a backlight adjustment value corresponding to a backlight adjustment parameter.

The effect level is a level divided according to how comfortable and clear the human eye receives the displayed content. For example, glare level, brighter level, slightly bright level, comfort level, slightly dark level, darker level and black level.

the step of adjusting the backlight brightness according to the visual adjustment information, the next frame display image, and the visual effect image includes the following steps:

Step S104-3a-1, obtaining a backlight adjustment parameter according to the effect level, the next frame display image, and the visual effect image.

Optionally, the visual adjustment information further includes a pixel color attribute difference threshold corresponding to the effect level.

The backlight adjustment parameter includes an effect level and a region percentage corresponding to the effect level.

The step of obtaining a backlight adjustment parameter according to the effect level, the next frame display image, and the visual effect image includes the following steps:

Step S104-3a-1-1, sequentially calculating a difference between a first pixel color attribute value and a corresponding second pixel color attribute value, so as to obtain a pixel color attribute difference value of a corresponding pixel.

Wherein the first pixel color attribute value is a pixel color attribute value of an effect pixel in the visual effect image, and the second pixel color attribute value is a pixel color attribute value of a frame pixel, corresponding to the effect pixel, in the next frame display image.

Since the visual effect image is a display effect that simulates the next frame display image, the specification size of the visual effect image is the same as that of the next frame display image. Therefore, each effect pixel in the visual effect image has a corresponding frame pixel in the next frame display image.

The purpose of calculating the pixel color attribute difference value is to find the pixel with the largest difference between the visual effect image and the next frame display image of the actual effect. Larger difference indicates greater distortion.

Step S104-3a-1-2, generating a color difference map according to the pixel color attribute difference value of each pixel.

The color difference map is a graph that represents the color attribute difference value by color.

Step S104-3a-1-3, dividing the color difference map into at least one or more effect level regions according to the pixel color attribute difference threshold.

Step S104-3a-1-4, obtaining the region percentage of each effect level according to the effect level regions and the color attribute difference map.

Step S104-3a-2, obtaining the corresponding backlight adjustment value according to the backlight adjustment parameter.

Step S104-3a-3, adjusting the backlight brightness according to the backlight adjustment value.

The embodiment obtains the backlight adjustment value by analyzing the difference between the visual effect image and the next frame display image, so as to adjust the display of the multimedia blackboard as a whole.

### The Embodiment

The visual adjustment information includes an effect comfort threshold, and a pixel color attribute adjustment parameter of a frame pixel corresponding to both a pixel color attribute value of an abnormal pixel and a pixel color attribute value of the frame pixel.

The step of adjusting the pixel color attribute value of the frame pixel in the next frame display image according to the visual adjustment information, the visual effect image, the first brightness distribution image, the next frame display image and the backlight brightness includes the following steps:

Step S104-3b-1, generating a third brightness distribution image according to the first brightness distribution image and the backlight brightness.

In the step S104-3b-1, the backlight brightness refers to a backlight brightness of the display device when no adjustment has been made after obtaining the next frame display image.

Step S104-3b-2, obtaining a non-comfortable effect region of the visual effect image according to the effect comfort threshold.

Step S104-3b-3, obtaining a corresponding fragment frame region in the next frame display image and a corresponding abnormal brightness region in the third brightness distribution image according to the non-comfortable effect region.

Step S104-3b-4, obtaining the pixel color attribute adjustment parameter of the corresponding frame pixel according to the pixel color attribute value of each frame pixel in the fragment frame region and the pixel color attribute value of the abnormal pixel corresponding to the frame pixel in the abnormal brightness region.

Step S104-3b-5, adjusting the pixel color attribute value of the corresponding frame pixel in the next frame display image according to the pixel color attribute adjustment parameter of each frame pixel in the fragment frame region.

The embodiment obtains an abnormal effect by analyzing the visual effect image, and improves the pixel color attribute value of the frame pixel in the abnormal effect region in the next frame display image, so as to achieve the purpose of adjusting the display of the multimedia blackboard.

### The Embodiment

The embodiment adjusts the display of the multimedia blackboard display by adjusting the backlight brightness, but the backlight brightness can be adjusted only when the display effect of the overall display device is weighed, that is, the overall adjustment. Therefore, the improvement of the display effect is limited. In order to further improve the display effect, in the third specific embodiment, a local adjustment is performed after the first specific embodiment is implemented.

Step S104-3c-1, generating a third brightness distribution image according to the first brightness distribution image and the backlight brightness.

In the step S104-3c-1, the backlight brightness refers to the adjusted backlight brightness in the first specific embodiment.

Step S104-3c-2, obtaining a non-comfortable effect region of the visual effect image according to the effect comfort threshold.

Step S104-3c-3, obtaining a corresponding fragment frame region in the next frame display image and a corresponding abnormal brightness region in the third brightness distribution image according to the non-comfortable effect region.

Step S104-3c-4, obtaining the pixel color attribute adjustment parameter of the corresponding frame pixel according to the pixel color attribute value of each frame pixel in the fragment frame region and the pixel color attribute value of the abnormal pixel corresponding to the frame pixel in the abnormal brightness region.

Step S104-3c-5, adjusting the pixel color attribute value of the corresponding frame pixel in the next frame display image according to the pixel color attribute adjustment parameter of each frame pixel in the fragment frame region.

After adjusting the brightness of the backlight, the third specific embodiment further fine-tunes the display image of the next frame, so as to achieve a better viewing effect.

In the embodiment of the present disclosure, before displaying the next frame display image, the pixel color attribute value of the image and/or the backlight brightness are adjusted according to the brightness of light illuminating the multimedia blackboard, which reduces the impact of ambient light on viewing the multimedia blackboard and improves the comfort of viewing the multimedia blackboard.

Corresponding to the embodiment provided by the present disclosure, the present disclosure also provides the embodiment, that is, a device for adjusting display of a multimedia blackboard. Since the embodiment is basically similar to the embodiment, it is described relatively simply. For related parts, please refer to the corresponding description of the first embodiment. The device embodiments described below are only schematic.

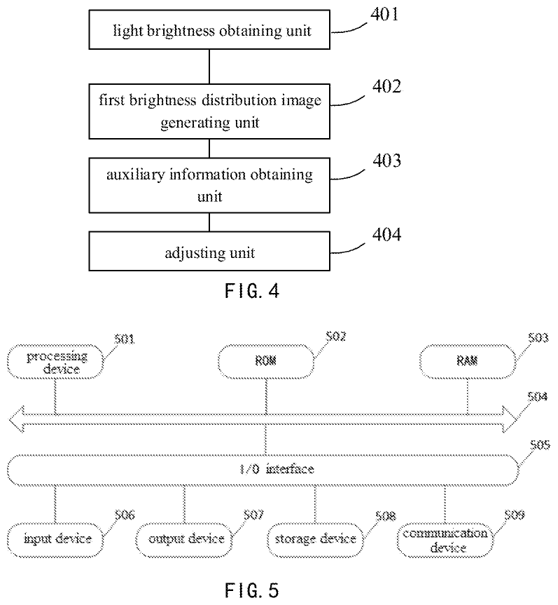

FIG. 4 illustrates an embodiment of a device for adjusting display of a multimedia blackboard provided by the present disclosure.

Referring to FIG. 4, the present disclosure provides a device for adjusting display of a multimedia blackboard display, including: a light brightness obtaining unit 401, a first brightness distribution image generating unit 402, an auxiliary information obtaining unit 403, and an adjusting unit 404.

The light brightness obtaining unit 401 is configured to obtain a set of brightnesses simultaneously acquired by a plurality of light sensors corresponding to each display device of the multimedia blackboard.

The first brightness distribution image generating unit 402 is configured to analyze each set of brightnesses and perform a smoothing processing to generate a first brightness distribution image corresponding to the display device.

The auxiliary information obtaining unit 403 is configured to obtain a next frame display image and a backlight brightness of each display device.

The adjusting unit 404 is configured to a pixel color attribute value of a frame pixel in the next frame display image and/or the backlight brightness of the corresponding display device according to a preset visual adjustment information, the first brightness distribution image, the next frame display image, and the backlight brightness of each display device.

Optionally, the adjusting unit 404 includes:

a second brightness distribution image generating sub-unit, configured to generate a second brightness distribution image according to the first brightness distribution image and the backlight brightness;

a visual effect image generating sub-unit, configured to generate a visual effect image corresponding to the next frame display image according to the second brightness distribution image and the next frame display image;

an adjusting sub-unit, configured to adjust the backlight brightness according to the visual adjustment information, the next frame display image, and the visual effect image, and/or to adjust the pixel color attribute value of the frame pixel in the next frame display image according to the visual adjustment information, the visual effect image, the first brightness distribution image, the next frame display image, and the backlight brightness.

Optionally, the visual adjustment information includes an effect level and a backlight adjustment value corresponding to a backlight adjustment parameter;

The adjusting sub-unit includes:

a backlight adjustment parameter obtaining sub-unit, configured to obtain a backlight adjustment parameter according the effect level, the next frame display image, and the visual effect image;

a backlight adjustment value obtaining sub-unit, configured to obtain the corresponding backlight adjustment value according to the backlight adjustment parameter;

a backlight brightness adjusting sub-unit, configured to adjust the backlight brightness according to the backlight adjustment value.

Optionally, the visual adjustment information further includes an effect level and a pixel color attribute difference threshold corresponding to the effect level.

The backlight adjustment parameter includes an effect level and a region percentage corresponding to the effect level;

The backlight adjustment parameter obtaining sub-unit includes:

a pixel color attribute difference value obtaining sub-unit, configured to sequentially calculate a difference between a first pixel color attribute value and a corresponding second pixel color attribute value, so as to obtain a pixel color attribute difference value of a corresponding pixel; wherein the first pixel color attribute value is a pixel color attribute value of an effect pixel in the visual effect image, and the second pixel color attribute value is a pixel color attribute value of a frame pixel, corresponding to the effect pixel, in the next frame display image;

a color difference map generating sub-unit, configured to generate a color difference map according to the pixel color attribute difference value of each pixel;

an effect level region dividing sub-unit, configured to divide the color difference map into at least one or more effect level regions according to the pixel color attribute difference threshold;

a region percentage obtaining sub-unit, configured to obtain the region percentage of each effect level according to the effect level regions and the color attribute difference map.

Optionally, the visual adjustment information includes an effect comfort threshold, and a pixel color attribute adjustment parameter of the frame pixel corresponding to both a pixel color attribute value of an abnormal pixel and a pixel color attribute value of the frame pixel.

The adjusting sub-unit includes:

a third brightness distribution image generating sub-unit, configured to generate a third brightness distribution image according to the first brightness distribution image and the backlight brightness;

a non-comfortable effect region obtaining sub-unit, configured to obtain a non-comfortable effect region of the visual effect image according to the effect comfort threshold;

a reference region obtaining unit, configured to obtain a corresponding fragment frame region in the next frame display image and a corresponding abnormal brightness region in the third brightness distribution image according to the non-comfortable effect region;

a pixel color attribute adjustment parameter obtaining sub-unit, configured to obtain the pixel color attribute adjustment parameter of the corresponding frame pixel according to the pixel color attribute value of each frame pixel in the fragment frame region and the pixel color attribute value of the abnormal pixel corresponding to the frame pixel in the abnormal brightness region;

a pixel color attribute value adjusting sub-unit, configured to adjust the pixel color attribute value of the corresponding frame pixel in the next frame display image according to the pixel color attribute adjustment parameter of each frame pixel in the fragment frame region.

Optionally, the plurality of light sensors constitute a light sensor array;

The light brightness obtaining unit 401 includes:

a light brightness obtaining sub-unit, configured to obtain a set of brightnesses simultaneously acquired by the light sensor array corresponding to each display device of the multimedia blackboard.

Optionally, the pixel color attribute value includes a contrast value, a color level value, a color temperature value, a color tone value, and/or a saturation value.

In the embodiment of the present disclosure, before displaying the next frame display image, the pixel color attribute value of the image and/or the backlight brightness are adjusted according to the brightness of light illuminating the multimedia blackboard, which reduces the impact of ambient light on viewing the multimedia blackboard and improves the comfort of viewing the multimedia blackboard.

The present disclosure provides a embodiment, that is, an electronic device which is suitable for a method of adjusting display of a multimedia blackboard. The electronic device includes: a transparent writing board; at least one or more display devices hermetically attached to an entire back of the writing board; a plurality of light sensors provided in the writing board; at least one processor; and a storage device communicatively connected to the at least one processor; wherein,

the storage device stores instructions executable by a processor, and the instructions are executed by the at least one processor, so that the at least one processor can execute the method of adjusting the display of the multimedia blackboard as described in the first embodiment.

The present disclosure provides a embodiment, that is, a computer storage medium that adjusts display of a multimedia blackboard, the computer storage medium stores computer-executable instructions. The computer-executable instructions can execute the method for adjusting the display of the multimedia blackboard as described in the first embodiment.

Referring to FIG. 5, a schematic structural diagram of an electronic device suitable for implementing the embodiments of the present disclosure is shown. A terminal device in the embodiment of the present disclosure may include, but is not limited to mobile terminals such as a mobile phone, a notebook computer, a digital broadcast receiver, a PDA (Personal Digital Assistant), a PAD (Tablet Computer), a PMP (Portable Multimedia Player), a vehicle-mounted terminal (e.g., car navigation terminal), or the like and fixed terminals such as a digital TV, a desktop computer or the like. The electronic device shown in FIG. 5 is only an example, and should not impose any limitation on the functions and scope of use of the embodiments of the present disclosure.

As shown in FIG. 5, the electronic device may include a processing device (e.g., a central processing unit, a graphics processing unit, etc.) 501, which may perform various appropriate actions and processes according to a program stored in a read-only memory (ROM) 502 or a program loaded into a random access memory (RAM) 503 from a storage device 508. In the RAM 503, various programs and data necessary for the operation of the electronic device are also stored. The processing device 501, the ROM 502, and the RAM 503 are connected to each other through a bus 504. An input/output (I/O) interface 505 is also connected to the bus 504.

Generally, the following devices can be connected to the I/O interface 505: an input device 506 such as touch screen, touch pad, keyboard, mouse, camera, microphone, accelerometer, gyroscope, or the like; an output device 507 such as liquid crystal display (LCD), speaker, vibrator, or the like; a storage device 508 such as magnetic tape, hard disk, or the like; and a communication device 509. The communication device 509 may allow the electronic device to perform wireless or wired communication with other devices to exchange data. Although FIG. 5 shows an electronic device having various devices, it should be understood that it is not required to implement or have all the devices as shown. More or fewer devices may be implemented or provided instead.

In particular, according to an embodiment of the present disclosure, the process described above with reference to the flowchart may be implemented as a computer software program. For example, an embodiment of the present disclosure include a computer program product including a computer program carried on a non-transitory computer-readable medium, the computer program containing program code for performing a method shown in the flowchart. In such an embodiment, the computer program may be downloaded and installed from the network through the communication device 509, or installed from the storage device 508, or installed from the ROM 502. When the computer program is executed by the processing device 501, the above functions defined in the method of the embodiment of the present disclosure are executed.

It should be noted that this disclosure of the above computer readable media may be a computer readable signal medium or a computer readable storage medium or any combination of the above. Computer readable storage media such as a system, device or device that can be, but not limited to, electricity, magnetism, light, electromagnetic, infrared, or semiconductor, or any combination of more than one. More specific examples of computer readable storage media may include, but are not limited to: electrical connections with one or more conductors, portable computer disks, hard drives, random access memory (RAM), read-only memory (ROM), erasable programmable read-only memory (EPROM or flash), optical fibers, portable compact disk read-only memory (CD-ROM), optical memory devices, magnetic memory devices, or any of the appropriate combinations described above. In this disclosure, a computer-readable storage medium may be any tangible medium containing or storing a program that may be directed for use by or in combination with an execution system, device or device. In this disclosure, the computer readable signal medium may include data signals propagated in the baseband or as part of the carrier, which carry computer readable program code. Such propagated data signals can take many forms, including but not limited to electromagnetic signals, optical signals, or any suitable combination of the above. A computer-readable signal medium may also be any computer-readable medium other than a computer-readable storage medium which may transmit, propagate or transmit a program for use or in combination with an instruction-executing system, device or device. Program code contained on a computer readable medium may be transmitted with any appropriate medium, including but not limited to: wires, optical cables, RF (rf), etc., or any suitable combination of the above.

In some embodiments, the client, server may communicate using any currently known or future developed network protocol such as the HTTP (hypertext transfer protocol, hypertext transfer protocol) and may interconnect with digital data communications (e.g., communication networks) of any form or medium. Examples of communication networks include local area networks (“LAN””), wide area networks (“WAN””), internet networks (e.g., internet), and end-to-end networks (e.g., ad hoc end-to-end networks), as well as any currently known or future developed networks.

The computer readable readable medium mentioned above may be contained in the electronic device mentioned above; It may also exist separately without being fitted to the electronic device.

One or more programming languages, or combinations thereof, can be used to code computer programs used to perform operations in this disclosure, including, but not limited to, object-oriented programming languages such as Java [symbol] Smalltalk [symbol] C, and conventional procedural programming languages such as “C” languages or similar programming languages. Program code can be executed completely on the user computer, partially on the user computer, as a separate package, partially on the user computer, or completely on the remote computer or server. Where a remote computer is involved, a remote computer can be connected to a user computer through any kind of network—including a local area network (LAN) or a wide area network (WAN)—or to an external computer (e.g. via the Internet using an Internet service provider).

Flowcharts and block diagrams in the attached drawings illustrating the possible implementation architecture, functions and operations of systems, methods and computer program products in accordance with the various embodiments disclosed herein. At this point, each box in a flow chart or block diagram can represent a module, program segment, or part of a code that contains one or more executable instructions for implementing a specified logical function. It should also be noted that in some of the replacement implementations, the functions marked in the box can also occur in a different order from those marked in the accompanying drawings. For example, two boxes represented consecutively can actually be executed essentially in parallel, and sometimes in reverse order, depending on the function involved. it is also important to note that each box in the block diagram and/or flow chart, as well as a combination of boxes in the block diagram and/or flow chart, can be implemented with a dedicated hardware-based system performing specified functions or operations, or with a combination of dedicated hardware and computer instructions.

The units described in this public embodiment can be implemented either software or hardware. where the name of the unit does not in some case constitute a qualification of the unit itself.

The functions described above in this paper can be performed at least partially by one or more hardware logic components. non-restrictive, hardware logic components of the demonstration type that can be used include: field programmable gate arrays (FPGA), dedicated integrated circuits (ASIC), dedicated standard products (ASSP), on-chip systems (SOC), complex programmable logic devices (CPLD), etc.

In the context of this disclosure, a machine readable medium may be a tangible medium that may contain or store programs for use by the instruction execution system, device or device or in combination with the instruction execution system, device or device. Machine readable media can be machine readable signal media or machine readable storage media. Machine readable media may include, but are not limited to, electronic, magnetic, optical, electromagnetic, infrared, or semiconductor systems, devices or devices, or any suitable combination of the above. More specific examples of machine readable storage media will include electrical connections based on one or more lines, portable computer disks, hard drives, random access memory (RAM), read-only memory (ROM), erasable programmable read-only memory (EPROM or flash memory), optical fiber, convenient compact disk read-only memory (CD-ROM), optical storage devices, magnetic storage devices, or any suitable combination of the above.

The above description is only a preferred embodiment of the present disclosure and an explanation of the applied technical principles. Those skilled in the art should understand that the scope of the disclosure involved in this disclosure is not limited to the technical solution of the specific combination of the above technical features, but also covers other technical solutions formed by any combination of the above technical features or their equivalent features without departing from the above-mentioned disclosure concepts. For example, a technical solution formed by replacing the above features with technical features disclosed in the present disclosure (but not limited to) with similar functions.

Furthermore, while operations are depicted in a particular order, this should not be understood as requiring them to be performed in the particular order shown or in sequential order. multitasking and parallel processing may be advantageous in a certain environment. Similarly, while a number of specific implementation details are included in the above discussion, these should not be interpreted as limiting the scope of this disclosure. certain features described in the context of a separate embodiment can also be implemented in combination in a single embodiment. in contrast, the various features described in the context of a single embodiment can also be implemented individually or in any appropriate sub-combination in multiple embodiments.

Although this topic has been described in a language specific to structural features and/or methodological logical actions, it should be understood that the subject defined in the accompanying claim is not necessarily limited to the particular features or actions described above. On the contrary, the specific features and actions described above are only an example form of the realization of the claim.

What is claimed is:

1. A method for adjusting display of a multimedia blackboard, comprising:
obtaining a set of brightnesses simultaneously acquired by a plurality of light sensors corresponding to each display device of the multimedia blackboard, wherein, the multimedia blackboard comprises: a transparent writing board, at least one or more display devices hermetically attached to an entire back of the writing board, and the plurality of light sensors provided in the writing board;
analyzing the set of brightnesses and perform a smooth processing to generate a first brightness distribution image of the corresponding display device;
obtaining a next frame display image and a backlight brightness of each display device; and
adjusting a pixel color attribute value of a frame pixel in the next frame display image and/or the backlight brightness of the corresponding display device according to a preset visual adjustment information, the first brightness distribution image, the next frame display image, and the backlight brightness of each display device.

2. The method according to claim 1, wherein the step of adjusting a pixel color attribute value of a frame pixel in the next frame display image and/or the backlight brightness of the corresponding display device according to a preset visual adjustment information, the first brightness distribution image, the next frame display image, and the backlight brightness of each display device comprises:
generating a second brightness distribution image according to the first brightness distribution image and the backlight brightness;
generating a visual effect image corresponding to the next frame display image according to the second brightness distribution image and the next frame display image; and
adjusting the backlight brightness according to the visual adjustment information, the next frame display image, and the visual effect image, and/or adjusting the pixel color attribute value of the frame pixel in the next frame display image according to the visual adjustment information, the visual effect image, the first brightness distribution image, the next frame display image and the backlight brightness.

3. The method according to claim 2, wherein the visual adjustment information comprises an effect level and a backlight adjustment value corresponding to a backlight adjustment parameter;
the step of adjusting the backlight brightness according to the visual adjustment information, the next frame display image, and the visual effect image comprises:
obtaining the backlight adjustment parameter according to the effect level, the next frame display image, and the visual effect image;
obtaining the corresponding backlight adjustment value according to the backlight adjustment parameter; and
adjusting the backlight brightness according to the backlight adjustment value.

4. The method according to claim 3, wherein the visual adjustment information further comprises the effect level and a pixel color attribute difference threshold corresponding to the effect level;
the backlight adjustment parameter comprises the effect level and a region percentage corresponding to the effect level;
the step of obtaining the backlight adjustment parameter according to the effect level, the next frame display image, and the visual effect image comprises:
sequentially calculating a difference between a first pixel color attribute value and a corresponding second pixel color attribute value, so as to obtain a pixel color attribute difference value of a corresponding pixel, where the first pixel color attribute value is a pixel color attribute value of an effect pixel in the visual effect image, and the second pixel color attribute value is the pixel color attribute value of the frame pixel, corresponding to the effect pixel, in the next frame display image.
generating a color difference map according to the pixel color attribute difference value of each pixel;
dividing the color difference map into at least one or more effect level regions according to the pixel color attribute difference threshold; and
obtaining the region percentage of each effect level according to the effect level regions and the color difference map.

5. The method according to claim 2, wherein the visual adjustment information comprises an effect comfort threshold, and a pixel color attribute adjustment parameter of the frame pixel corresponding to both a pixel color attribute value of an abnormal pixel and the pixel color attribute value of the frame pixel;
the step of adjusting the pixel color attribute value of the frame pixel in the next frame display image according to the visual adjustment information, the visual effect image, the first brightness distribution image, the next frame display image and the backlight brightness comprises:
generating a third brightness distribution image according to the first brightness distribution image and the backlight brightness;
obtaining a non-comfortable effect region of the visual effect image according to the effect comfort threshold;
obtaining a corresponding fragment frame region in the next frame display image and a corresponding abnormal brightness region in the third brightness distribution image according to the non-comfortable effect region;
obtaining the pixel color attribute adjustment parameter of the corresponding frame pixel according to the pixel color attribute value of each frame pixel in the fragment frame region and the pixel color attribute value of the abnormal pixel corresponding to the frame pixel in the abnormal brightness region; and
adjusting the pixel color attribute value of the corresponding frame pixel in the next frame display image according to the pixel color attribute adjustment parameter of each frame pixel in the fragment frame region.

6. The method according to claim 1, wherein the plurality of light sensors constitute a light sensor array;
the step of obtaining a set of brightnesses simultaneously acquired by a plurality of light sensors corresponding to each display device of the multimedia blackboard comprises:
obtaining a set of brightnesses simultaneously acquired by the light sensor array corresponding to each display device of the multimedia blackboard.

7. The method according to claim 1, wherein the pixel color attribute value comprises: a contrast value, a color level value, a color temperature value, a color tone value, and/or a saturation value.

8. A device for adjusting display of a multimedia blackboard, which is applied to a multimedia blackboard, the multimedia blackboard comprising: a transparent writing board, at least one or more display devices hermetically attached to an entire back of the writing board, and the plurality of light sensors provided in the writing board, wherein the device comprises:
a brightness obtaining unit, configured to obtain a set of brightnesses simultaneously acquired by a plurality of light sensors corresponding to each display device of the multimedia blackboard;
a first brightness distribution image generating unit, configured to analyze the set of brightnesses and perform a smooth processing to generate a first brightness distribution image of the corresponding the display device;
an auxiliary information obtaining unit, configured to obtain a next frame display image and a backlight brightness of each display device; and
an adjusting unit, configured to adjust a pixel color attribute value of a frame pixel in the next frame display image and/or the backlight brightness of the corresponding display device according to a preset visual adjustment information, the first brightness distribution image, the next frame display image, and the backlight brightness of each display device.

9. A computer-readable storage medium in which a computer program is stored, wherein when the program is executed by a processor, the method according to claim 1 is implemented.

10. An electronic device, comprising:
a transparent writing board;
at least one or more display devices hermetically attached to an entire back of the writing board;
a plurality of light sensors provided in the writing board;
one or more processors;
a storage device configured to store one or more programs, wherein when the one or more programs are executed by the one or more processors, the one or more processors are caused to implement the method according to claim 1.
